(19) United States
(12) Patent Application Publication
(10) Pub. No.: US 2021/0272601 A1
(43) Pub. Date: Sep. 2, 2021

(54) SYSTEMS, METHODS AND INTERACTIVE GRAPHICAL USER INTERFACES FOR AUTOMATED VIDEO PRODUCTION

(71) Applicant: Mitchell A. Bennett, Brooklyn, NY (US)

(72) Inventor: Mitchell A. Bennett, Brooklyn, NY (US)

(21) Appl. No.: 17/187,671

(22) Filed: Feb. 26, 2021

Related U.S. Application Data
(60) Provisional application No. 62/982,625, filed on Feb. 27, 2020.

(51) Int. Cl. G11B 27/036

(52) U.S. Cl. CPC G11B 27/036

(57) ABSTRACT

Exemplary embodiments include a secure intelligent networked architecture for automated content production (such as video production) including a secure intelligent automated content production agent having a specialized hardware processor and a memory, the secure intelligent automated content production agent configured to automatically receive a digital data element over a network from a computing device, the digital data element representing an instruction for content production before the content is received by the secure intelligent automated content production agent. The secure intelligent automated content production agent is configured to receive media to use as input for a camera track and configured to receive a script file based on a current export setting. The secure intelligent automated content production agent is also configured to compress a project into a zip file and configured to allow preview and testing of a script on a computing device.

### CROSS-REFERENCE TO RELATED APPLICATIONS

The present U.S. Non-Provisional Patent Application claims the priority benefit of U.S. Provisional Patent Application Ser. No. 62/982,625 filed on Feb. 27, 2020, titled, “Systems, Methods and Interactive Graphical User Interfaces for Instant Video Production,” the entirety of which is incorporated by reference herein.

### FIELD OF EXEMPLARY EMBODIMENTS

The exemplary embodiments herein are related to the production of digital content immediately following capture.

### SUMMARY OF EXEMPLARY EMBODIMENTS

Exemplary embodiments include a secure intelligent networked architecture for automated content production including a secure intelligent automated content production agent having a specialized hardware processor and a memory, the secure intelligent automated content production agent configured to automatically receive a digital data element over a network from a computing device, the digital data element representing an instruction for content production before the content is received by the secure intelligent automated content production agent. The secure intelligent automated content production agent is configured to receive media in a variety of forms (or other data) to use as input for a camera track and/or other types of track (including a plurality of tracks, and tracks such as audio, video, graphics, text, images, effects, filter, transition, pre-recorded audio and/or video, etc.) and configured to receive a script file based on a current export setting. The secure intelligent automated content production agent is also configured to compress a project into a zip file and configured to allow preview and testing of a script on a computing device. The zip file also allows for portability in the transfer of the zip file between computing devices, including cloud servers.

According to many exemplary embodiments, the secure intelligent automated content production agent is configured with an editor for editing a code file in a media panel and configured to import media for referencing in a JavaScript file. The secure intelligent automated content production agent is configured to export to a wide variety of computing devices (such as a mobile device, laptop device, cloud server) a script comprising a music track and an overlay track for blending with a camera track on a computing device. The computing device then may be used to capture content and transmit the captured content to the secure intelligent automated content production agent.

Also provided herein are exemplary methods for automated content production including a secure intelligent automated content production agent automatically receiving a digital data element over a network from a computing device, the digital data element representing an instruction for content production before the media or input is received by the secure intelligent automated content production agent. The secure intelligent automated content production agent then receives media to use as input for a camera track and receives a script file based on a current export setting.

In further exemplary embodiments, the secure intelligent automated content production agent allows for the editing of a code file in a media panel and importing media for referencing in a JavaScript file. The secure intelligent automated content production agent then compresses a project into a zip file. Additionally, the secure intelligent automated content production agent allows preview and testing of a script on a computing device. The secure intelligent automated content production agent provides for exporting to a computing device a script comprising a music track and an overlay track for blending with a camera track on a computing device. The computing device captures content and transmits the captured content to the secure intelligent automated content production agent.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods, systems and interactive graphical user interfaces disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 shows an exemplary secure intelligent networked architecture for automated content production.

FIGS. 2-20 are screenshots of exemplary interactive graphical user interfaces.

### DETAILED DESCRIPTION

The following detailed description includes references to the accompanying drawings, which form a part of the detailed description. The drawings show illustrations in accordance with exemplary embodiments. These exemplary embodiments, which are also referred to herein as “examples,” are described in enough detail to enable those skilled in the art to practice the present subject matter. The embodiments can be combined, other embodiments can be utilized, or structural, logical, and changes can be made without departing from the scope of what is claimed. The following detailed description is, therefore, not to be taken in a limiting sense, and the scope is defined by the appended claims and their equivalents.

It will be understood that the functionalities described herein, which are attributed to the system and application may also be executed within the client. That is, the client may be programmed to execute the functionalities described herein.

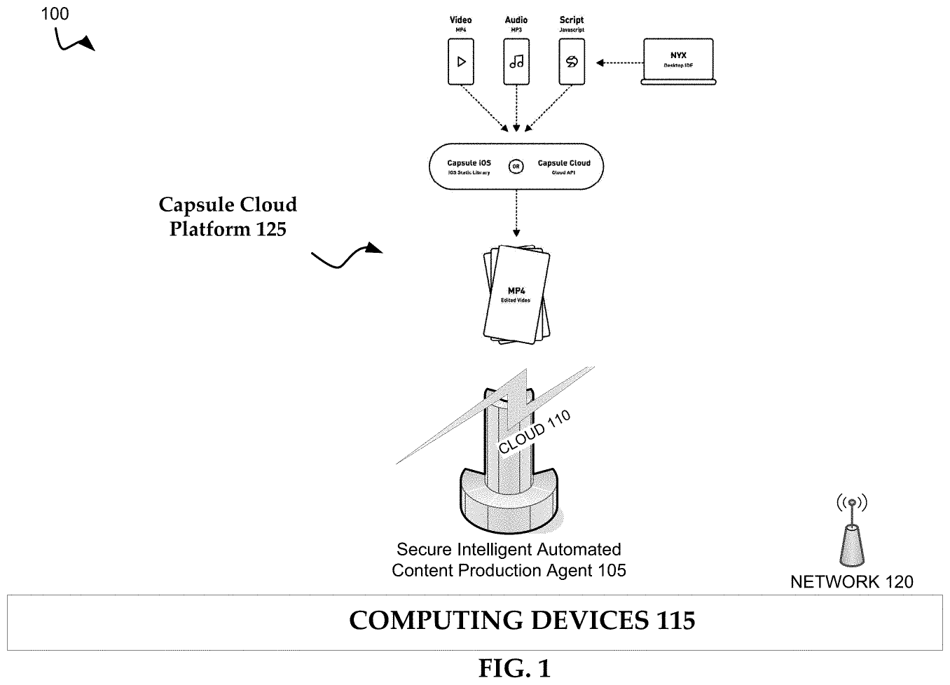

FIG. 1 shows an exemplary secure intelligent networked architecture for automated content production.

Shown in architecture 100 is a secure intelligent automated content production agent 105 (cloud 110 based), cloud 110, computing devices 115, network 120 and the capsule cloud platform 125 (cloud 110 based).

Advantageously, the exemplary embodiments described and illustrated herein provide for the simultaneous production of digital content as it is being captured. That is, the editing and formatting selections are provided before the digital content is captured. Accordingly, digital content can be captured, edited, formatted and transmitted to as few people or as many people and platforms (e.g. social media, email, text) desired. Distribution of digital content to platforms can be automated. Processing resources and time are dramatically reduced and transmission of digital content is accelerated.

For example, a user opens an application on a computing device 115 before proceeding to capture digital content. The user is then provided with the ability to preview the digital content, showing the digital content as edited and formatted by the predefined instructions/script. The user is then provided with the ability to upload the digital content. The digital content is uploaded to the cloud 110 where it is hosted forever and stored in an asset management tool which performs data analytics on the digital content.

Exemplary embodiments include a secure intelligent networked architecture 100 for automated content production including a secure intelligent automated content production agent 105 having a specialized hardware processor and a memory, the secure intelligent automated content production agent configured to automatically receive a digital data element over a network 120 from a computing device 115, the digital data element representing an instruction for content production before the content is received by the secure intelligent automated content production agent 105. The secure intelligent automated content production agent 105 is configured to receive media to use as input for a camera track and configured to receive a script file based on a current export setting.

According to many exemplary embodiments, the secure intelligent automated content production agent is configured with an editor for editing a code file in a media panel and configured to import media for referencing in a JavaScript file. The secure intelligent automated content production agent is configured to export to a computing device a script comprising a music track and an overlay track for blending with a camera track on a computing device. The secure intelligent automated content production agent 105 is also configured to compress a project into a zip file and configured to allow preview and testing of a script on a computing device. This compression reduces storage requirements for both the secure intelligent automated content product agent 105 and the computing device 115 (as well as processing resources and time for the computing device 115). The computing device then may be used to capture content and transmit the captured content to the secure intelligent automated content production agent.

In greater detail, the Capsule Cloud Platform 125 provides a pipeline for capturing, processing, managing, and delivering photo and video content. Here are the core components:

Capsule Script API—Programmatically sequence and process video. The typical inputs to this API are video and other media assets, plus a script that defines how these are remixed to generate the output video. Capsule scripts are written in JavaScript and provided is an IDE called Nyx for authoring and previewing these scripts. JavaScript on its own has no video editing capabilities, however, the inventors developed it to have video editing capabilities resulting in a proprietary JavaScript API.

Capsule Admin—Central hub for configuring, managing, monitoring, and delivering content generated on the Capsule Platform. Capsule Admin also provides an API for custom integrations.

Capsule Cloud—Gives developers a way to leverage the Script API from any online application, at scale. Can optionally upload to Capsule Admin.

Capsule Pro—an iOS app can be used to capture, process, and preview content. It uses the Capsule Script API for video processing and uploads to Capsule Admin.

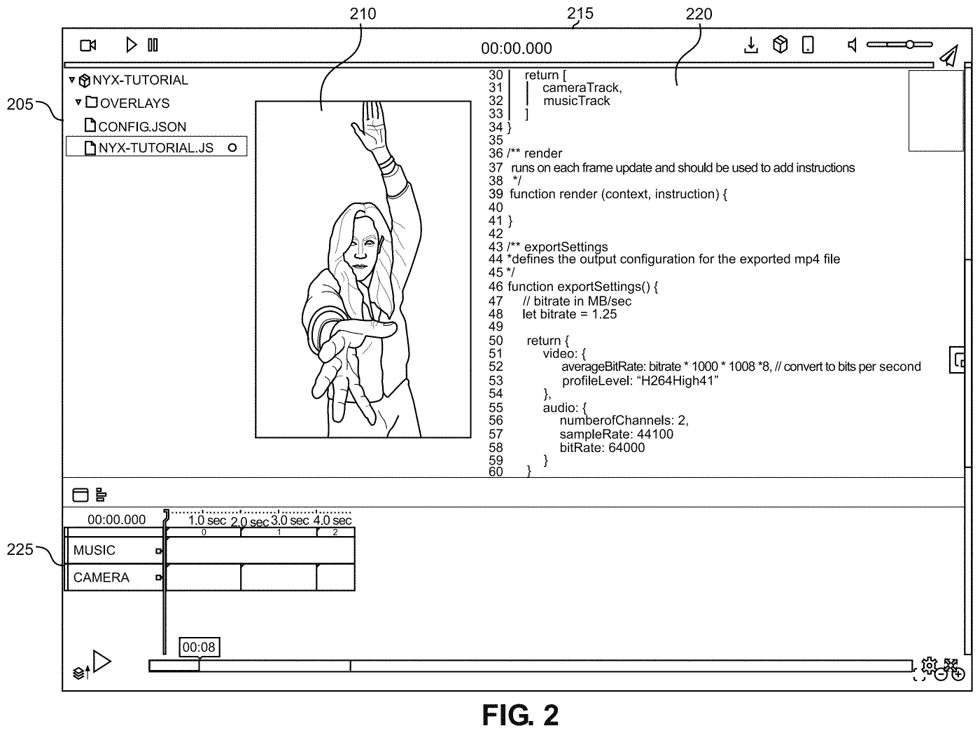

FIG. 2 is a first screenshot of an exemplary interactive graphical user interface. It has five panels: the control bar 215 across the top, the media panel 210 to the upper left where one can see all of their media, the viewer 210 to the right of the media panel where one can preview script, the code editor panel 220 to the right of the viewer and the timeline twin bars 225 running from left to right across the lower bottom.

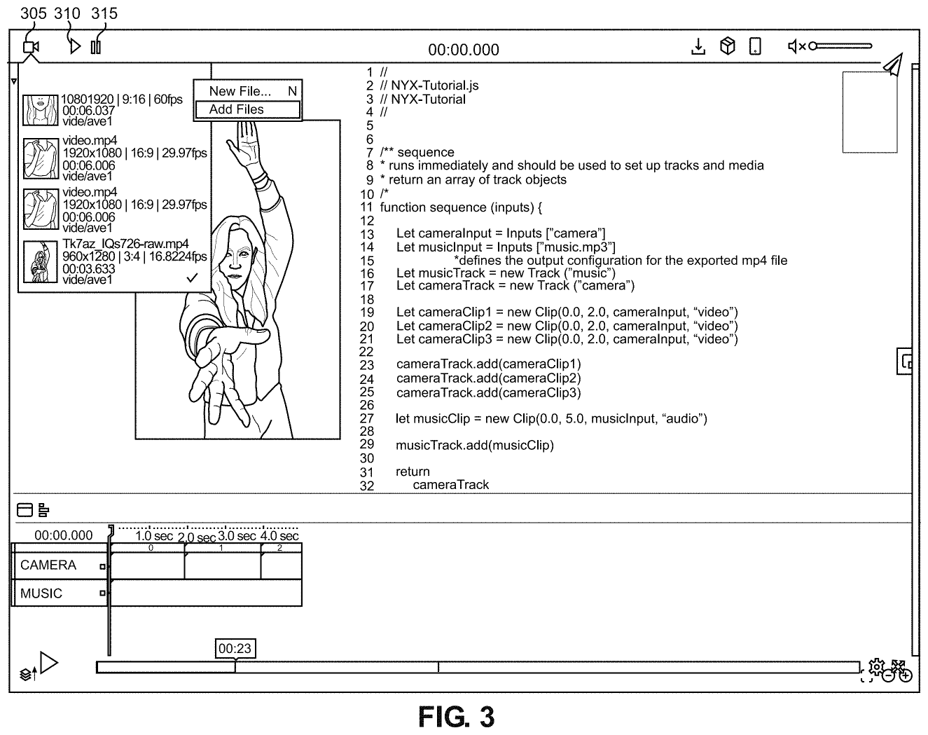

FIG. 3 is a second screenshot of an exemplary interactive graphical user interface. Going from left to right across the control bar, one can select the camera icon 305 on the upper left to import media to use as the input for one's camera track. Also shown to the right of the camera icon are the play 310 and pause 315 buttons (respectively) to control the play of media in the viewer.

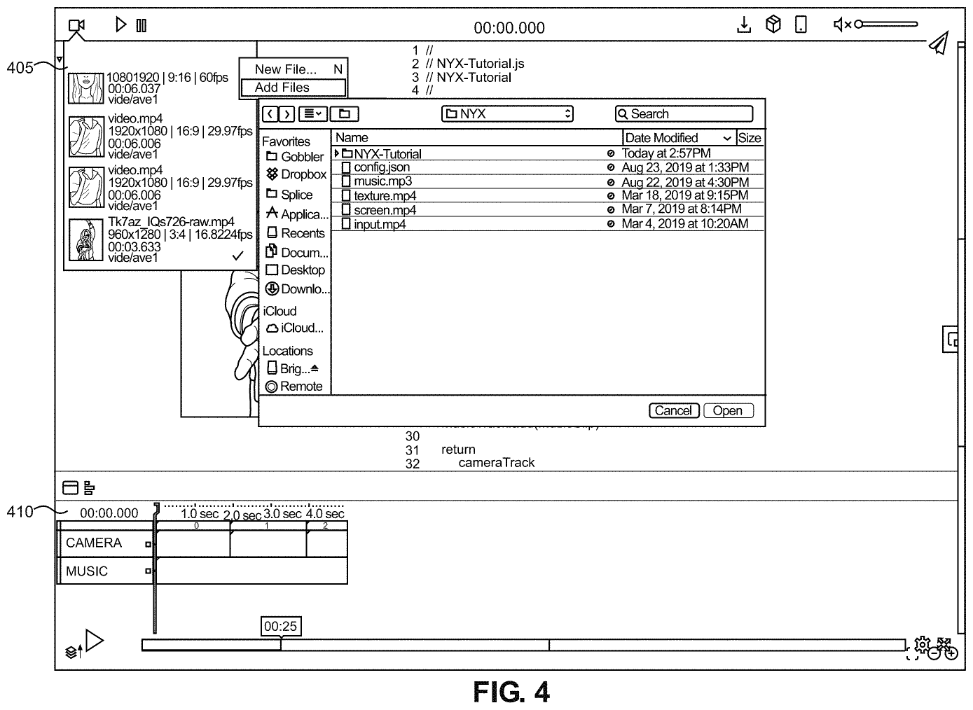

FIG. 4 is a third screenshot of an exemplary interactive graphical user interface. One can record webcam footage 405 to import media to use as the input. The time code 410 above the timeline twin bars tells where the cursor is at in the timeline.

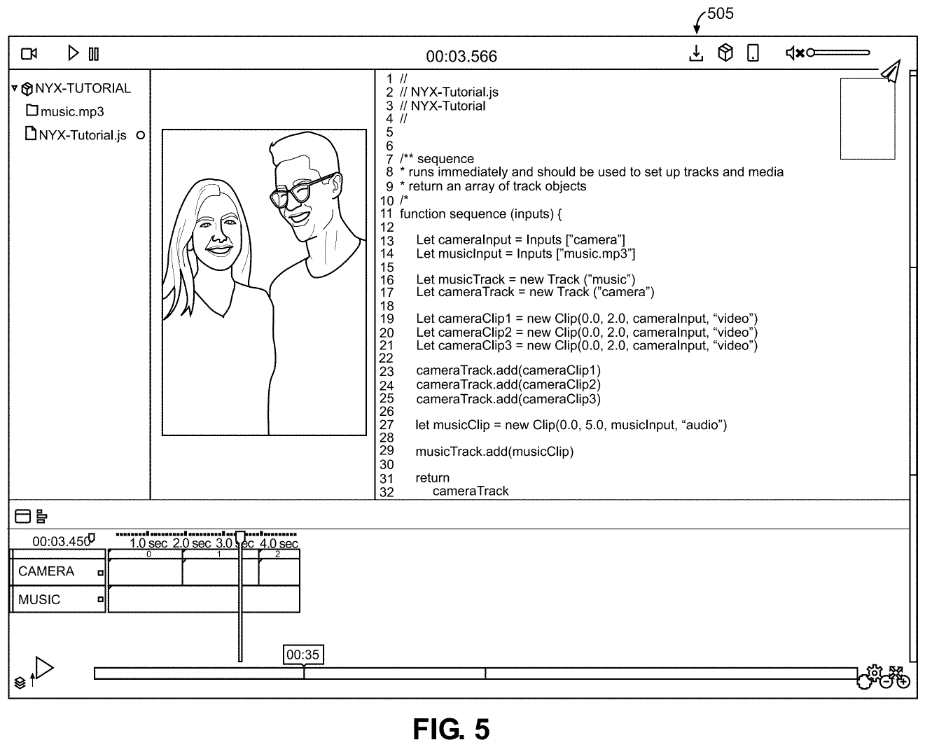

FIG. 5 is a fourth screenshot of an exemplary interactive graphical user interface. Using the download button 505 on the control bar, one can download a script file based on one's current export settings.

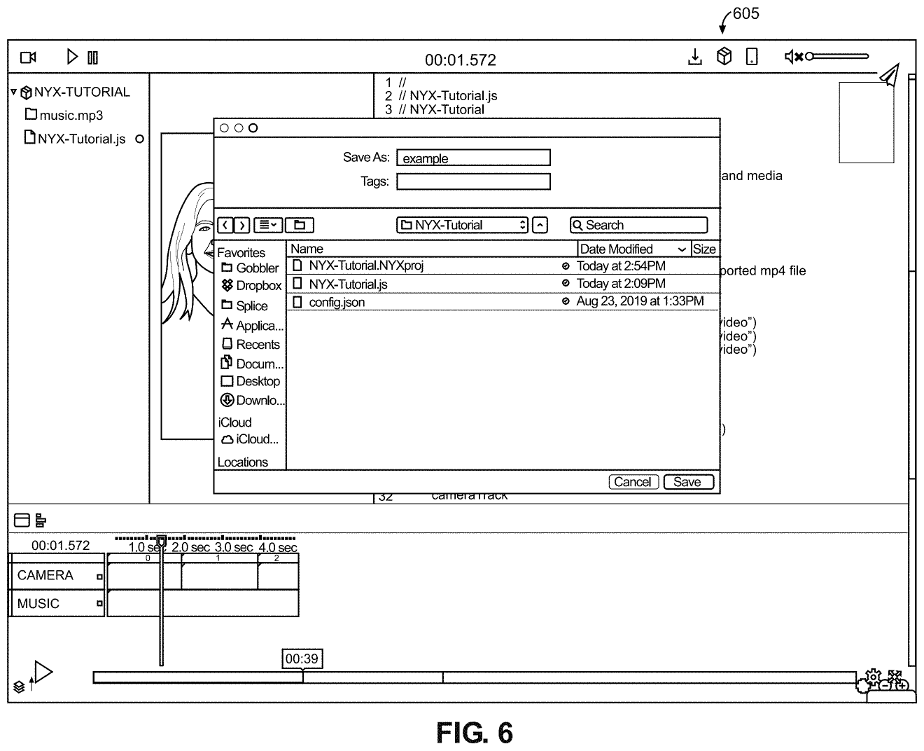

FIG. 6 is a fifth screenshot of an exemplary interactive graphical user interface. The package icon 605 on the control bar compresses one's entire project, including all media into a zip file so it can be shared.

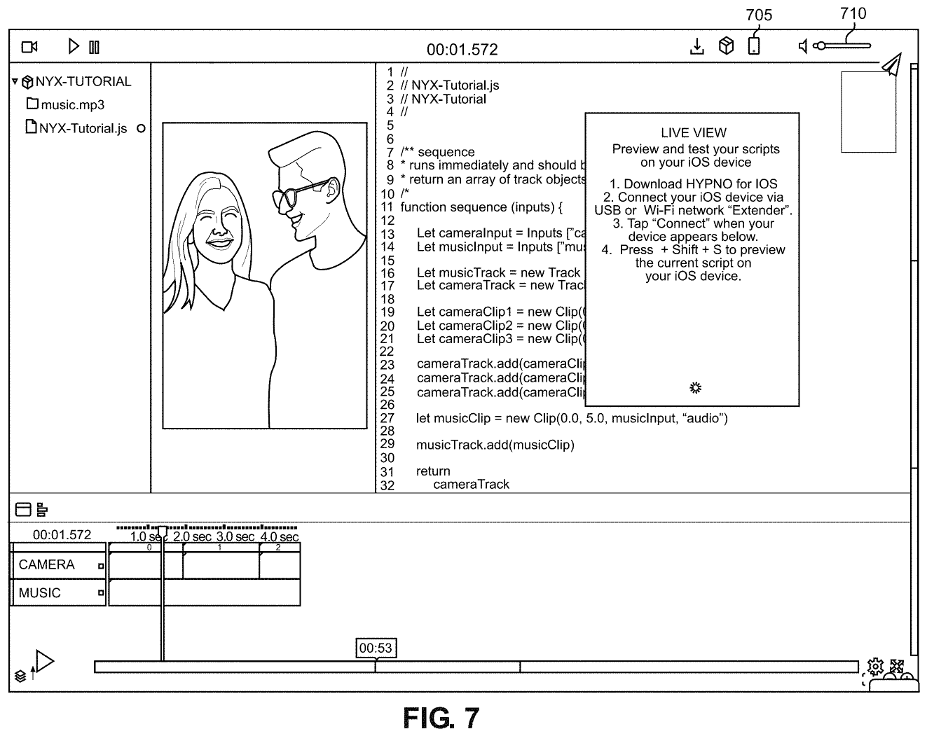

FIG. 7 is a sixth screenshot of an exemplary interactive graphical user interface. The phone icon 705 on the control bar is for live viewing, so one can preview and test scripts on an iOS device (or similar device). The volume icon 710 on the upper right of the control bar adjusts the playback volume when one is previewing the script.

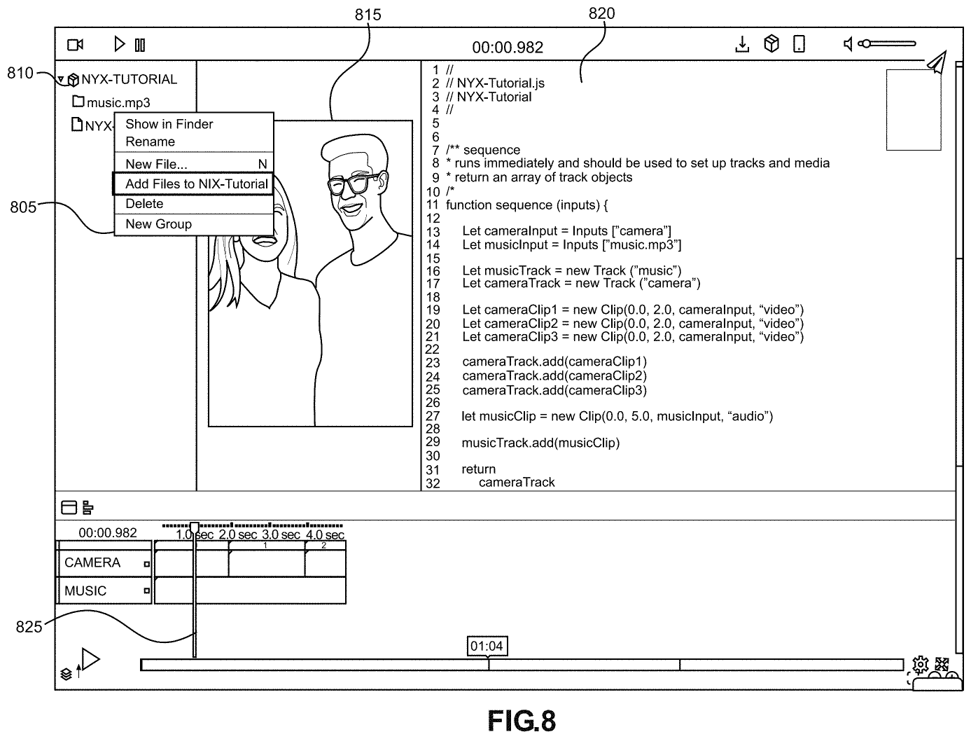

FIG. 8 is a seventh screenshot of an exemplary interactive graphical user interface. On the left side of the window is the media panel, which is where one can import and organize media. Whatever file one currently has selected in the media panel can show up in the editor panel 820. In this panel, one can drag and drop to import, reorder and organize media into folders. To make a new folder, right click on the cube icon 810 and select “new group 805.” On the right side is the editor 820. This is where one can edit the code file currently selected in the media panel.

If one has an audio or video file selected in the media panel, one can scrub through the file and play it back. The viewer 815 shows one's script output at the current cursor mark. This is where one can playback the script. The timeline on the bottom shows a visual interface of the tracks (the twin bars) and has an interactive cursor 825.

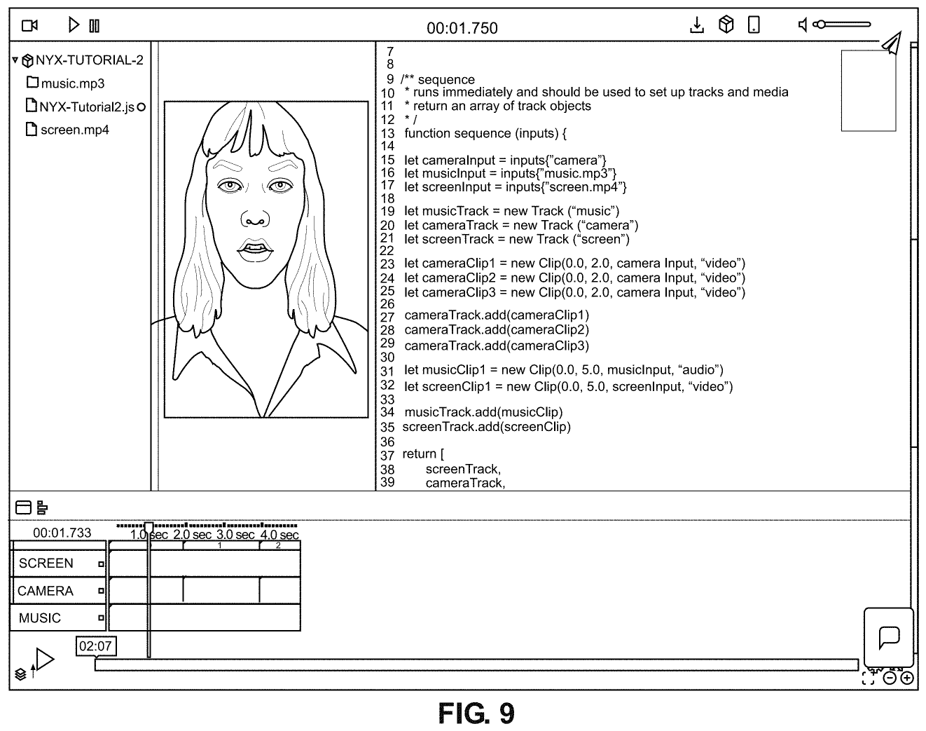

FIG. 9 is an eighth screenshot of an exemplary interactive graphical user interface. To get started with a script, one needs to import the media that will be referenced in the JavaScript file, such as overlay files and music files.

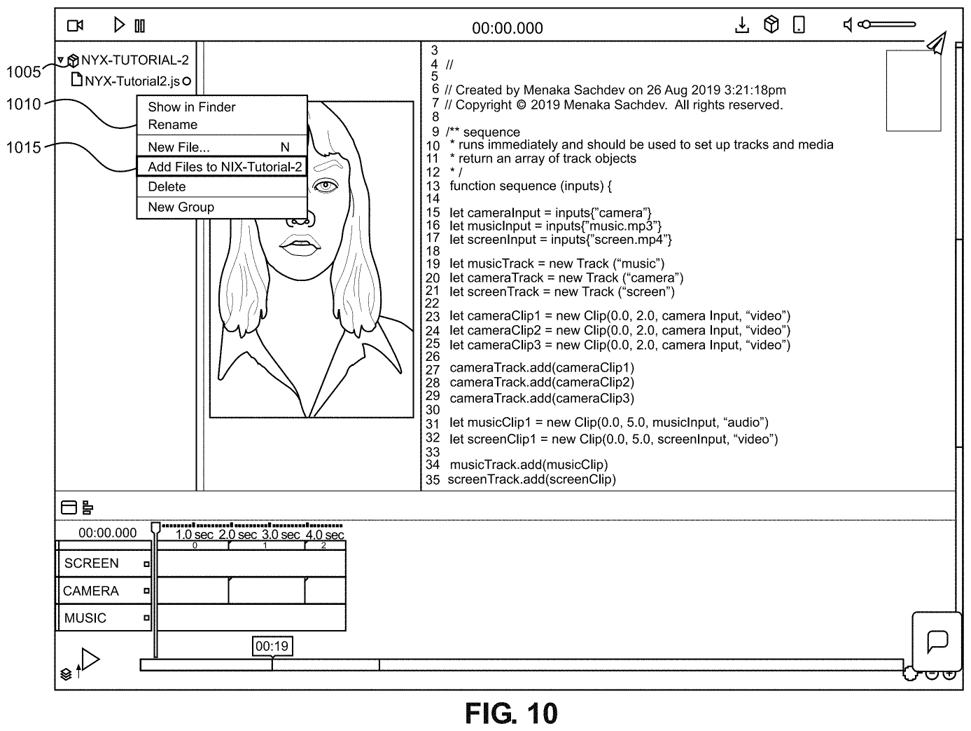

FIG. 10 is a ninth screenshot of an exemplary interactive graphical user interface. There are two ways to import media. First, one may right click on the project folder 1005. In the top left corner of the media panel 1010, one will see a drop down menu and select “Add Files 1015.”

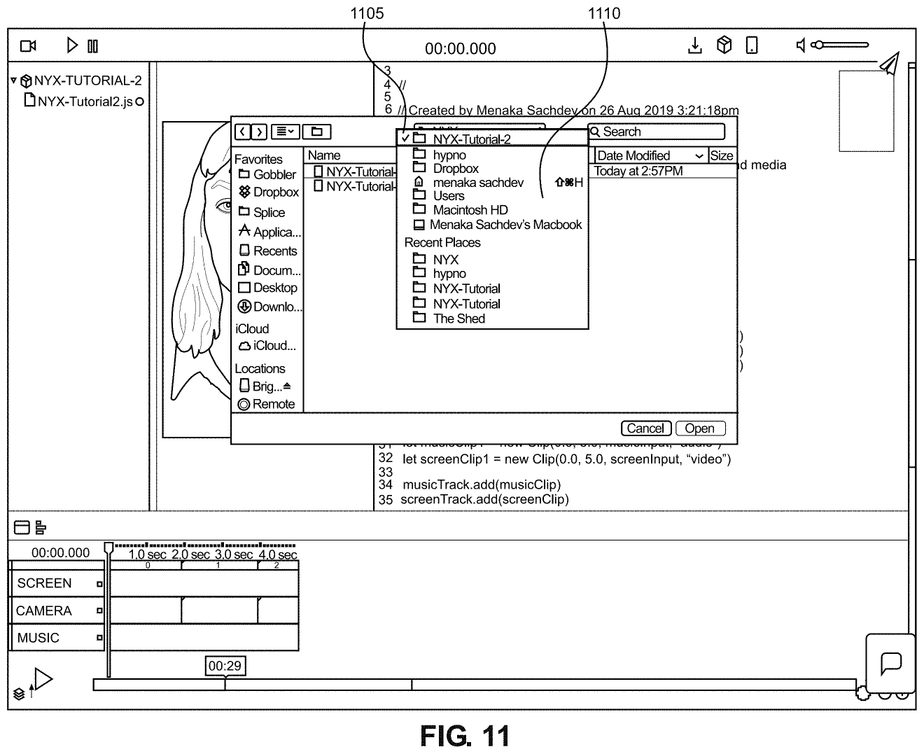

FIG. 11 is a tenth screenshot of an exemplary interactive graphical user interface. After selecting “Add Files,” the interactive graphical user interface will automatically be populated with the project name 1105. A dialog box 1110 will pop up prompting one to select the desired media to import. If everything is organized in one place, one can save time by selecting multiple files to import everything at once. The other way to import is by simply dragging and dropping files right into the media panel.

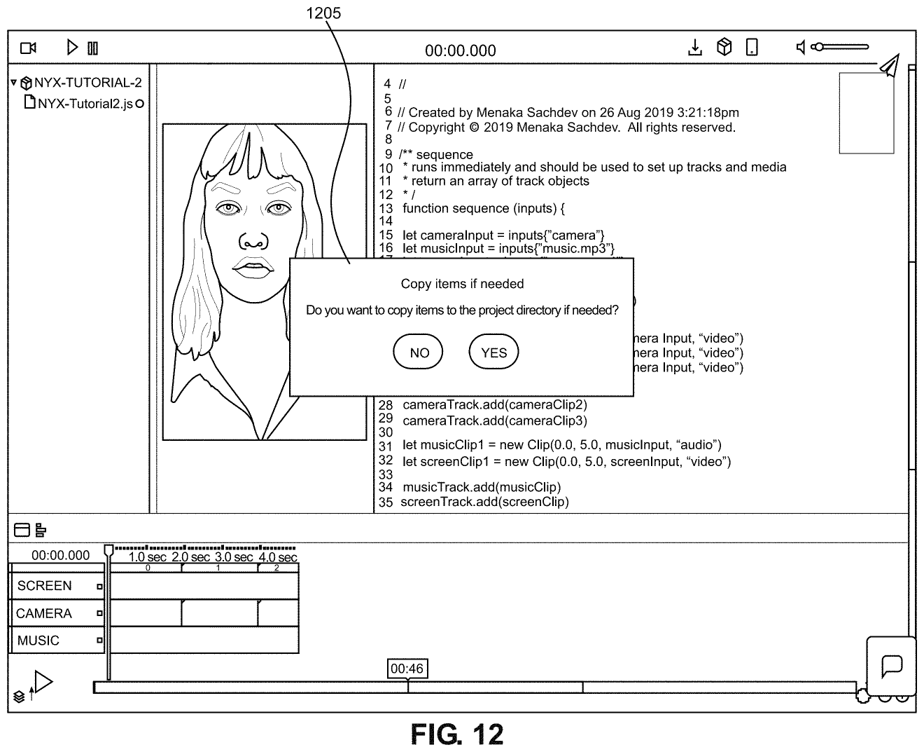

FIG. 12 is an eleventh screenshot of an exemplary interactive graphical user interface. Once the media to import has been chosen, one will be asked whether to copy files into the project folder 1205. It is suggested to always copy media into the project folder. If one wishes to send a next project to someone else, or copy the folder to another computer, one will not run into issues with finding the media.

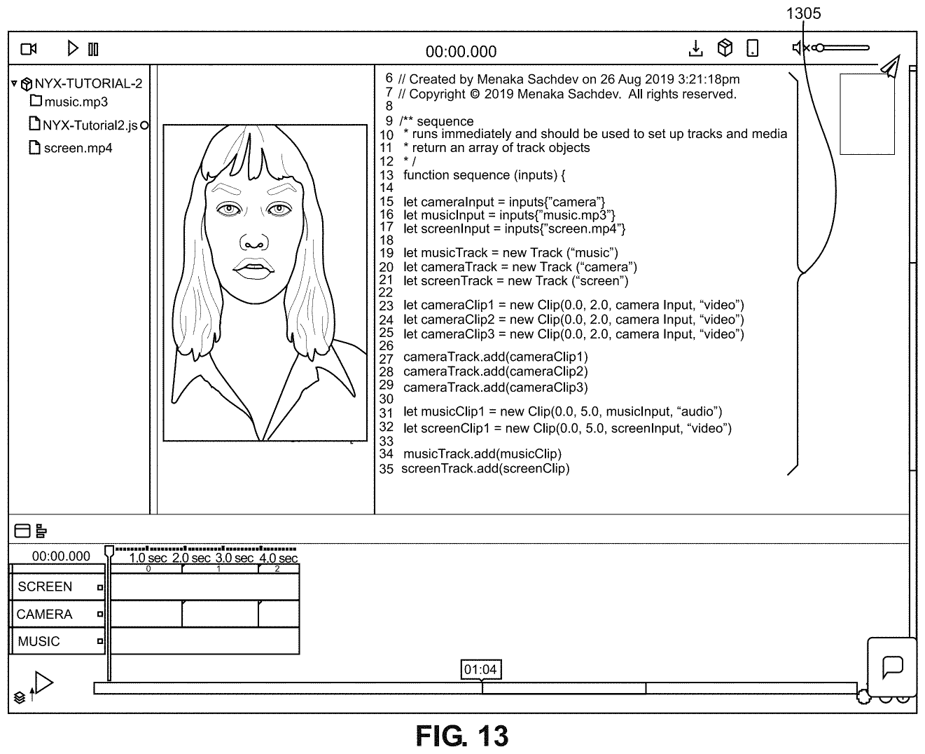

FIG. 13 is a twelfth screenshot of an exemplary interactive graphical user interface. Now that all the media is imported, it is time to pull up the script 1305. This script comprises a music track and an overlay track that one can use to blend with the camera track. As illustrated in the figure, the script references the media imported as the inputs for the overlay and music tracks.

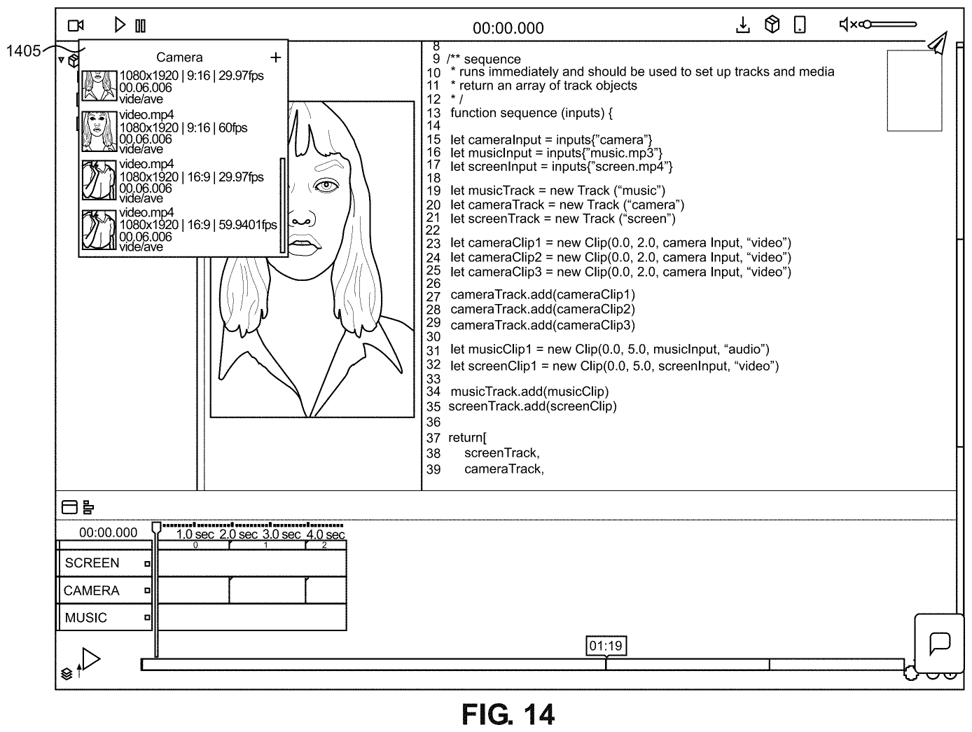

FIG. 14 is a thirteenth screenshot of an exemplary interactive graphical user interface. As illustrated, in the top left corner on the control bar, one can select one of the sample camera inputs 1405 to use as playback. When running the script on a phone, the camera input references the recording made during capture.

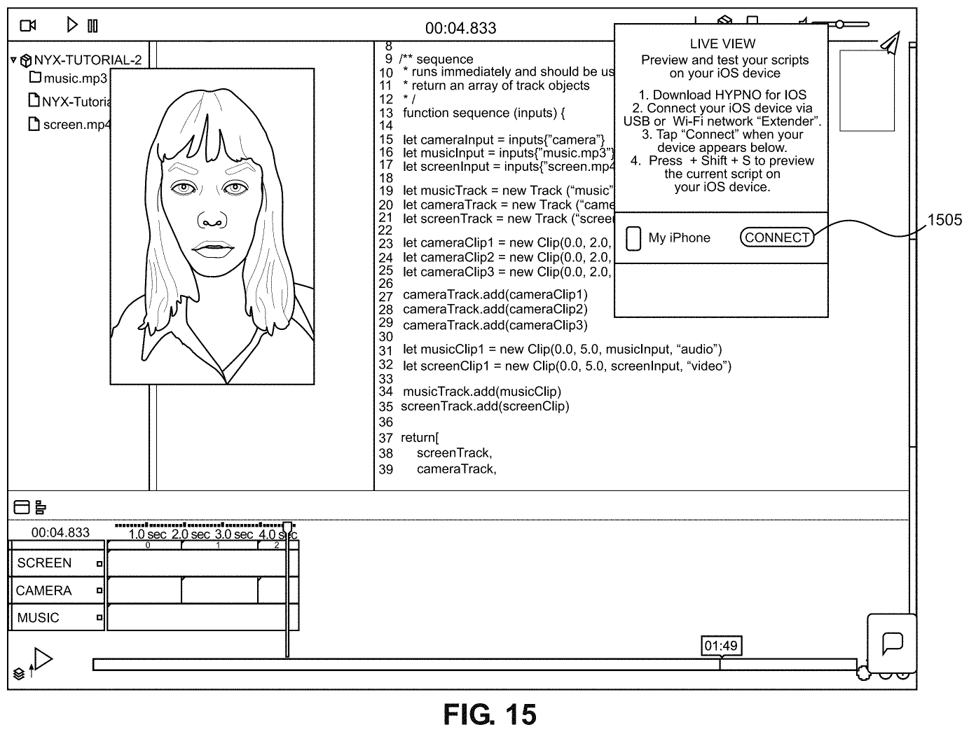

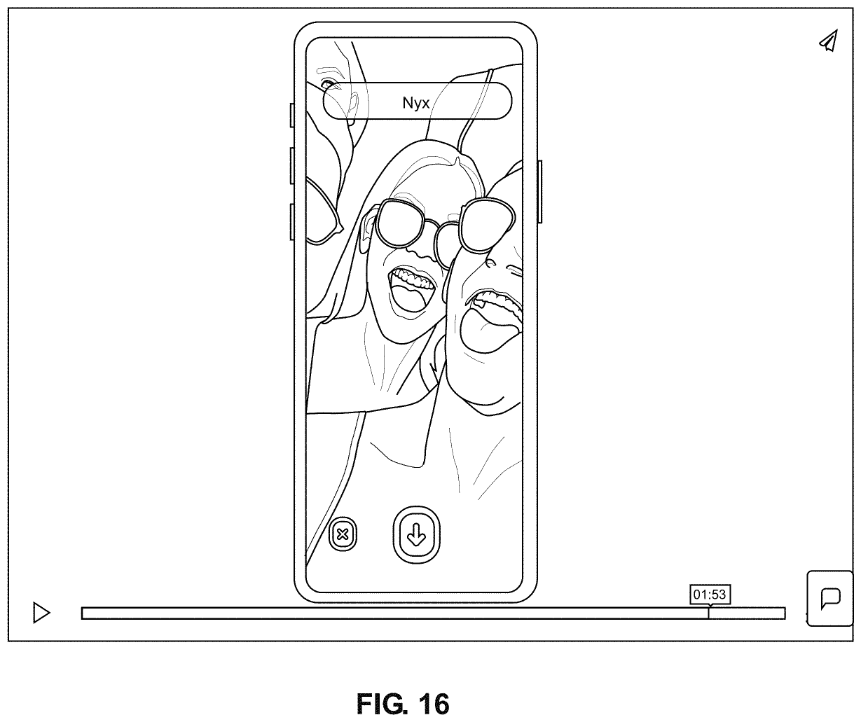

FIG. 15 is a fourteenth screenshot of an exemplary interactive graphical user interface. Once everything is working with the script, one can upload it to an iPhone or similar device to see it in action. Use a corresponding app from an app store on the iPhone or similar device. Make sure the iPhone is connected to the same Wi Fi network as the computer or is connected via USB to a computer. Click on the phone icon in the top right corner on the control bar and tap connect 1505 when the device appears in the drop down menu. Then press connect to preview the current script on the device as shown in FIG. 16.

Advantageously, the exemplary embodiments described and illustrated herein provide for the automated production of digital content immediately following when it is captured. That is, the editing and formatting selections are provided before the digital content is captured.

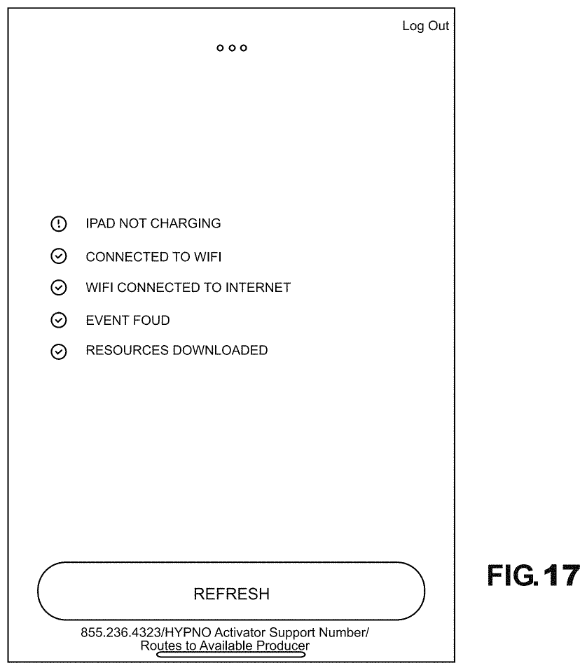

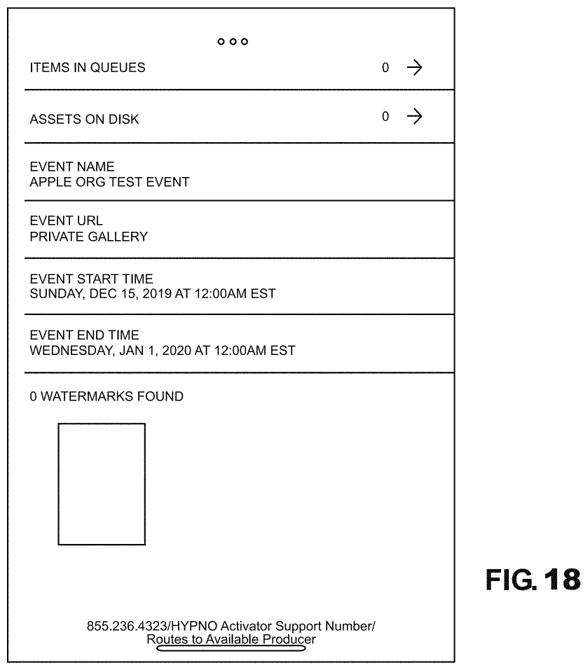

There are a variety of computing devices for capturing content, including web interfaces. For example, a user opens the user facing application as shown on a computing device. FIGS. 17-18 show exemplary screenshots for a status update for the mobile computing device before proceeding to capture digital content. Another screen, similar to that in FIG. 16, is a camera mode that provide instructions for properly capturing the digital content. Such instructions may include “show your face,” “come closer,” and a 3-2-1 countdown. The user is then provided with the ability to preview the digital content, showing the digital content as edited and formatted by the platform. The user is then provided with the ability to upload the digital content. The digital content is uploaded to the cloud where it is hosted forever and stored in an asset management tool which performs data analytics on the digital content.

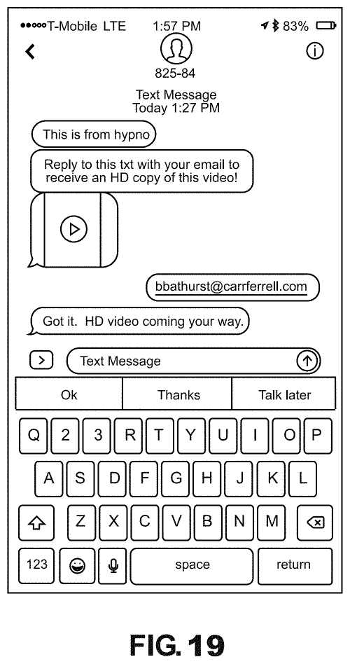

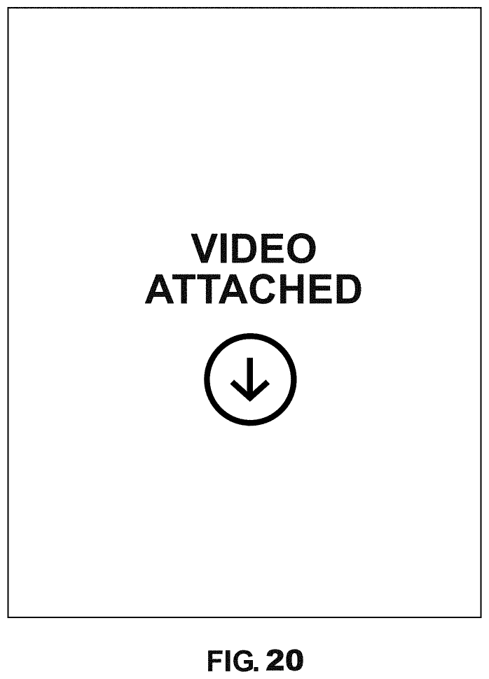

Turning to FIG. 19, after uploading the digital content, the user can provide their phone number and/or other contact information to receive a text from the platform. Upon providing the user's email address, the platform will email the user a HD video as shown in FIG. 20, where the user may also share it through various mechanisms, including social media.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the invention for various embodiments with various modifications as are suited to the particular use contemplated.

Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense. There are many alternative ways of implementing the present technology. The disclosed examples are illustrative and not restrictive.

What is claimed is:

1. A secure intelligent networked architecture for automated content production comprising:
a secure intelligent automated content production agent having a specialized hardware processor and a memory, the secure intelligent automated content production agent configured to automatically receive a digital data element over a network from a computing device, the digital data element representing an instruction for content production before the content is received by the secure intelligent automated content production agent.

2. The secure intelligent networked architecture for automated content production of claim 1, further comprising:
the secure intelligent automated content production agent configured to receive media to use as input for a camera track.

3. The secure intelligent networked architecture for automated content production of claim 1, further comprising:
the secure intelligent automated content production agent configured to receive a script file based on a current export setting.

4. The secure intelligent networked architecture for automated content production of claim 1, further comprising:
the secure intelligent automated content production agent configured to compress a project into a zip file.

5. The secure intelligent networked architecture for automated content production of claim 1, further comprising:
the secure intelligent automated content production agent configured to allow preview and testing of a script on a computing device.

6. The secure intelligent networked architecture for automated content production of claim 1, further comprising:
the secure intelligent automated content production agent configured with an editor for editing a code file in a media panel.

7. The secure intelligent networked architecture for automated content production of claim 1, further comprising:
the secure intelligent automated content production agent configured to import media for referencing in a JavaScript file.

8. The secure intelligent networked architecture for automated content production of claim 1, further comprising:
the secure intelligent automated content production agent configured to export to a computing device a script comprising a music track and an overlay track for blending with a camera track on a computing device.

9. The secure intelligent networked architecture for automated content production of claim 8, further comprising:
the computing device capturing content.

10. The secure intelligent networked architecture for automated content production of claim 9, further comprising the computing device transmitting the captured content to the secure intelligent automated content production agent.

11. A method for automated content production comprising:
a secure intelligent automated content production agent automatically receiving a digital data element over a network from a computing device, the digital data element representing an instruction for content production before the content is received by the secure intelligent automated content production agent.

12. The method for automated content production of claim 11 further comprising:
the secure intelligent automated content production agent receiving media to use as input for a camera track.

13. The method for automated content production of claim 11 further comprising:
the secure intelligent automated content production agent receiving a script file based on a current export setting.

14. The method for automated content production of claim 11 further comprising:
the secure intelligent automated content production agent compressing a project into a zip file.

15. The method for automated content production of claim 11 further comprising:
the secure intelligent automated content production agent allowing preview and testing of a script on a computing device.

16. The method for automated content production of claim 11 further comprising:
the secure intelligent automated content production agent editing a code file in a media panel.

17. The method for automated content production of claim 11 further comprising:
the secure intelligent automated content production agent importing media for referencing in a JavaScript file.

18. The method for automated content production of claim 11 further comprising:
the secure intelligent automated content production agent exporting to a computing device a script comprising a music track and an overlay track for blending with a camera track on a computing device.

19. The method for automated content production of claim 18 further comprising:
the computing device capturing content.

20. The method for automated content production of claim 19 further comprising:
the computing device transmitting the captured content to the secure intelligent automated content production agent.
